(19) United States
(12) Patent Application Publication
(10) Pub. No.: US 2006/0223396 A1
(43) Pub. Date: Oct. 5, 2006

(54) Thermo textile with carbon black polyester

(75) Inventors: Yung-Mao Huang, Taoyuan (TW); Ming-Lung Wu, Taoyuan (TW)

Correspondence Address: Jackson Walker L.L.P., Suite 2100, 112 E. Pecan Street, San Antonio, TX, 78205, US

(73) Assignee: Trueway Corporation

(21) Appl. No.: 11/096,975

(22) Filed: Apr. 1, 2005

(51) Int. Cl. B32B 5/02

(52) U.S. Cl. 442/59

(57) ABSTRACT

A textile is applicable for wet suits, jacket, sleeping bags, quilts and protection equipment includes a carbon black polyester fiber yarn mixed with a yarn after being processed so as to be a thermo textile.

### BACKGROUND OF THE INVENTION

1. Field of the Invention

The present invention relates to a thermo textile, and more particularly to a textile with carbon black polyester so as to keep warm a wearer of a garment etc made from such textile. The textile is applied to make diving suits, surfing suits, sleeping bags, quilts and protective wear, and is woven or knitted with yarn having at least 30% of carbon black polyester by weight. After processing, the textile of the present invention has abilities of maintaining warmth, being anti-bacterial and being anti-static so as to prolong activity time in cold environments, which is also a breakthrough in the material for making diving suits, surfing suits, sleeping bags, quilts and other protective wear.

2. Description of Related Art

Garments for water activities such as diving suits or surfing suits are often a major limitation for the activity time in that the warmth retention ability of these garments is low and thus the wearers are not able to do activities on/under water for a long period of time.

If the protective wear has a high warmth retention feature, the protective wear is able to help blood circulation, which not only upgrades the effectiveness of the protection, but also expands the application scope of the protective wear.

It is the primary objective of this invention to search for a temperature maintaining material for making diving suits, surfing suits, jackets, quilts, sleeping bags or the like for users to work for a long period of time in a low temperature environment. Conventionally, thick fabrics such as terry cloth, fleece fabric and/or felt fabric are used as a lining for protective wear, diving suits or surfing suits. This kind of application not only has low warmth retention ability, but also increases the wearer's burden in regards to the heavy weight of the fabric. Those fabrics are sometimes used to laminate with rubber sponge, which can cause breathlessness, humidity and bacteria propagation.

To overcome the shortcomings, the present invention tends to provide an improved textile made by carbon black polyester to mitigate the aforementioned problems.

### SUMMARY OF THE INVENTION

The primary objective of the present invention is to provide a textile having therein carbon black polyester to effectively maintain the wearer's body temperature so that the wearer is able to prolong the time for water activities.

In one aspect of the present invention, the textile has at least 30% of carbon black polyester by weight mixed with a yarn and is applicable for fabrication of wet suits, protective wear, sleeping bags, quilts or the like.

In yet another aspect of the present invention, the textile of the present invention has abilities of being anti-bacterial, being anti-static and promoting blood circulation.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of the present invention;
FIG. 2 is a flow chart of the present invention; and
FIG. 3 is a flow chart of the present invention.

### DETAILED DESCRIPTION OF THE PREFERRED EMBODIMENT

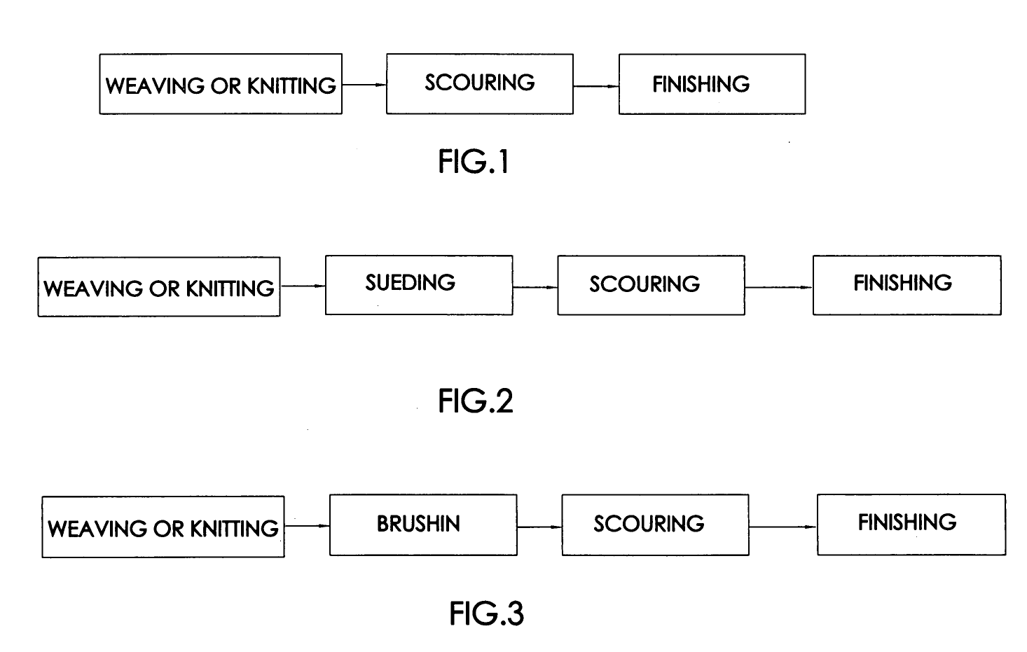

With reference to FIGS. 1, 2 and 3, it is noted that the textile in accordance with the present invention is a mixture of a yarn and at least 30% of carbon black polyester yarn by weight. After processing, the textile is suitable for making wet suits, jackets, sleeping bags, quilts and protective wear and has abilities of maintaining the wearer's body temperature.

The carbon black polyester yarn is made by filament or staple fiber which contains graphite particles.

During the weaving or knitting process of the carbon black polyester yarn, different textile patterns may be introduced depending on the design such as single jersey textile, double jersey textile, check textile or rib textile.

The textile processing normally is a combination of multiple tasks and includes scouring, brushing/sueding and finishing processes. With reference to FIGS. 1-3, the scouring process has a function to clean the textile, the brushing/sueding process is able to make the textile to have a fleecy surface so as to increase wearer's comfort and enhance temperature maintaining ability and the finishing process is to adjust the hand feel of the textile and to stabilize the dimension of the textile.

The textile of the present invention weighs 150 g/y (gram per yard) to 450 g/y and has a fabric width from 45 inch to 64 inch.

Taking the 75 denier carbon black polyester yarn and 40 denier elastic yarn for example, it is found that after scouring, brushing/sueding and finishing processes, a single jersey textile having a fabric width of 56 inch and yard weight 280 g/y is obtained.

Taking the 75 denier carbon black polyester yarn and 75 denier PTT yarn for example, it is found that after scouring, brushing/sueding and finishing processes, a check textile having a fabric width of 54 inch and yard weight 225 g/y is obtained.

Table 1 is a comparison of the textile of the present invention to the conventional textile, wherein the surface temperature difference of the present invention is up to 13 to 14° C., which shows the temperature maintaining capability of the textile of the present invention.

TABLE 1

| | | | | Thermo textile | | |
|---|---|---|---|---|---|---|
| | | Wool | Terry | (single Jersey | Thermo textile | |
| Item | | textile | cloth | textile) | (check textile) | Test method |
| Thermo capability | | 5° C. | 2° C. | 14° C. | 13° C. | Heat source: |
| (surface | | | | | | 500 W Halogen |
| temperature | | | | | | lamp |
| difference) | | | | | | Exposure time: |
| | | | | | | 10 mm. |
| Anti-bacterial rate | | <1% | <1% | 95% | 95% | AATCC 100- |
| (%) | | | | | | 1998 |
| Voltage | Cotton | — | 2381 | 588 | 697 | JIS L1094-1996 |
| after | Wool | — | 2637 | 266 | 163 | Method B |

| | | | | | |
|---|---|---|---|---|---|
| friction | | | | | |
| (V) | | | | | |
| Surface resistance | 10¹⁰ | 10¹¹ | 10⁸ | 10⁸ | Direct |
| (Ω) | | | | | measurement |

In conclusion, the textile of the present invention is superior to the conventional textile and has anti-bacterial and static proof capabilities so that the textile is novel in the industry and the industrial application is also proved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A textile being applicable for wet suits, jackets, sleeping bags, quilts and protective wear having a carbon black polyester yarn mixed with a yarn, after being processed so as to be a thermo textile, wherein the carbon black polyester yarn has at least 30% by weight compared with the yarn, and the carbon black polyester yarn is made by a material consisting essentially of filament or staple fiber which contains graphite particles.

2. (canceled)

3. (canceled)

4. The textile as claimed in claim 1, wherein the process includes scouring, brushing/sueding and finishing.
